(19) United States
(12) Patent Application Publication
(10) Pub. No.: US 2007/0028169 A1
(43) Pub. Date: Feb. 1, 2007

(54) Getting started assistance

(75) Inventor: Cynthia D. Wessling, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/192,224

(22) Filed: Jul. 28, 2005

(51) Int. Cl. G06F 9/00

(52) U.S. Cl. 715/705

(57) ABSTRACT

A list of goals is displayed that may be selected by user to get started on a project using an application. Rather than requiring the user to know how to best achieve the selected goal using the functionality of a specific application, a user may choose a goal and a solution to get started. After selecting the goal, the user is presented with various solutions that may be used to get started. For example, the selected goal may be to attract new customers and in response to the selection the application may display a list of publications that may be created to attract new customers. Selecting one of the solutions leads the user to resources that will assist them in achieving their goal.

### BACKGROUND

Starting to work on a project is often difficult for a user. For instance, if a user wants to create marketing materials to market their business, they may not know what type of marketing pieces to create. If a user wants to create a marketing brochure for their business they must determine the best software to use and then they need to know how to create the brochure using the software. Many users, however, do not know where to start within the software application to create the brochure. To assist users in getting started on projects templates have been developed to provide the user with a starting point. A template may be as simple as a blank document in the desired size and orientation or a template may be very detailed and include a detailed design with placeholder text, fonts, and graphics that are minimally altered by the user. Selecting from the available templates, however, requires a user to have the knowledge of what type of template they need in the first place. This is a non-trivial task as there are thousands of different templates that exist for a variety of applications. There are business templates, legal templates, label templates, calendar templates, resume templates, cover letter templates, spreadsheet templates, medical form templates, as well as many more types of templates. For example, even if the user knows they want to create a marketing brochure, what type of publication do they choose? They could choose a general catalog, a direct marketing catalog, an informational brochure, a price list brochure, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

When a user does not know how to get started on a project within an application, they may select a goal from a list of goals to assist them in getting started on their project. Rather than requiring the user to know how to best achieve the selected goal using the functionality of a specific application, a user may instead choose a goal and a solution to get started. After selecting the goal, the user is presented with various solutions that may be used to get started. For example, the selected goal may be to attract new customers and in response to the selection the application may display a list of publication types that may be created with a publishing application to attract new customers. Selecting one of the solutions leads the user to resources that will assist them in starting their project.

### BRIEF DESCRIPTION OF THE DRAWINGS

FIG. 1 illustrates an exemplary computing device;

FIG. 2 illustrates a getting started system;

FIG. 3 shows a goal with related solutions and resources;

FIG. 4 illustrates an exemplary getting started user interface;

FIGS. 5-7 show exemplary screen displays illustrating a getting started example; and

FIG. 8 shows a getting started process, in accordance with aspects of the present invention.

### DETAILED DESCRIPTION

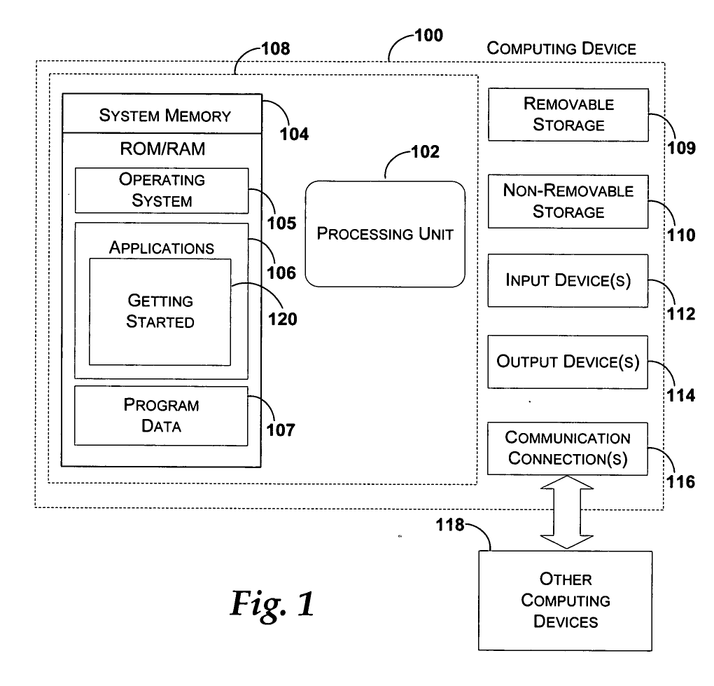

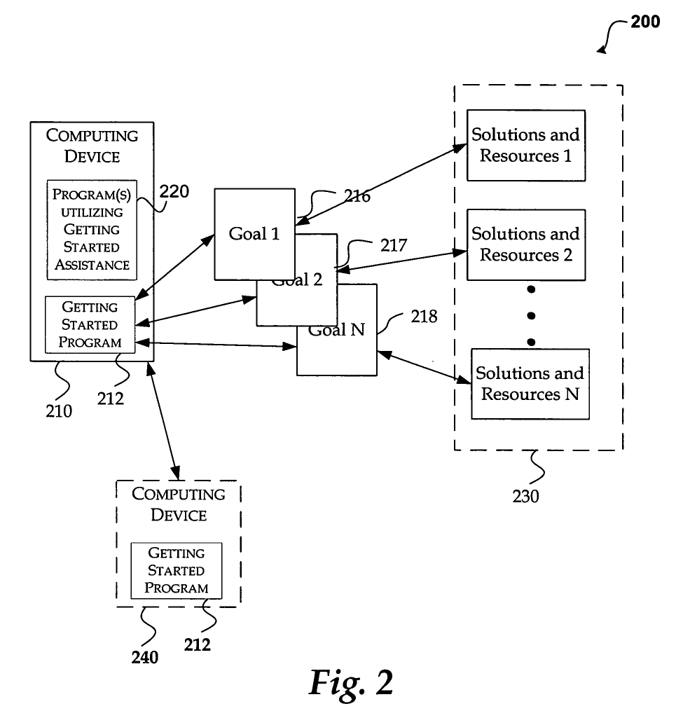

FIG. 2 illustrates a getting started system, in accordance with aspects of the invention. As illustrated, system 200 includes computing devices 210 and 240, goals 1-N (216, 217 and 218) and solutions and resources 230 that include solutions and resources 1 through N. Computing device 210 and computing device 240 are computing devices such as the one described in conjunction with FIG. 1.

Computing device 210 is configured to run getting started program 212. Getting started program 212 interacts with one or more programs on computing device 210 and is configured to provide a list of goals (216-218), related solutions and the appropriate resources (230) to assist a user in getting started with a project based on the selection of one of the goals. Although getting started program 212 is illustrated as a separate program from the program (220), the functionality of getting started program 212 may be combined within a single program. Getting started program 212 may also be located on a separate computing device, such as computing device 240.

Generally, programs (220) utilize getting started program 212 to provide a user with help in getting started with a project that is based upon a goal of the user. The goal may relate to many different ideas. For example, an exemplary program (220) could be a publishing application in which the user would like a list of goals relating to marketing. More specifically, the goal may be to attract new customers, provide incentives to customers, increase repeat customers, and the like. When the user determines and selects the goal (216-218) they would like to achieve, getting started program 212 determines the solutions and their appropriate resources based on the goal.

The goals may be stored externally from program 212. For example, the goals may be stored within an XML file that may be accessed by getting started program 212. In this way, the goals may be updated without having to redistribute the program(s) (220). The goal or goals may also be coded into the program itself. Each of the goals has one or more solutions and associated resources that are used in getting started.

The resources may be any type of resource that may be utilized by a program. For example, the resource may be an article, another program, a network site, a database, and the like. The solutions and resources may be located on the same computing device or on another computing device from the getting started program. When located on a different computing device, data relating to the resources may be transmitted over a wide area network (WAN)/local area network (LAN) and/or cellular/pager network or some other network.

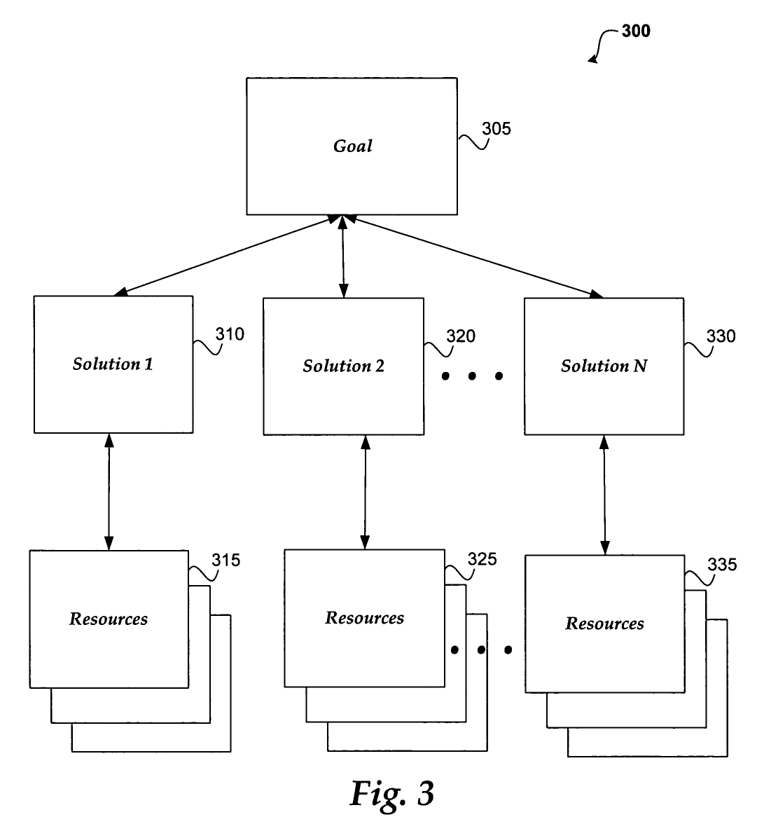

FIG. 3 shows a goal with related solutions and resources, in accordance with aspects of the invention. Goal 305 is one of the goals that may be selected by a user. The goal is directed at determining a starting point for a user within an application. The goal is typically related to the purpose of the application for which it is associated. For example, when the application is a publishing application, goal 305 may be related to areas in which creating a publication would be utilized. For instance, goal 305 may be a goal to market effectively to customers which may require creating a specific type of brochure using the publishing application. When the application is a spreadsheet application, the goal may be to effectively manage customers which may require the use of a spreadsheet. The number and type of goals that may be defined is unlimited.

Organized under goal 305 are solutions (310, 320 and 330) that may be selected by a user to assist achieving goal 305. For example, each of the solutions may relate to the different types of documents that a program may create that would accomplish the goal. Each solution may include a set of resources. For example, the resources could be application functionality, network references, articles, publications, and the like.

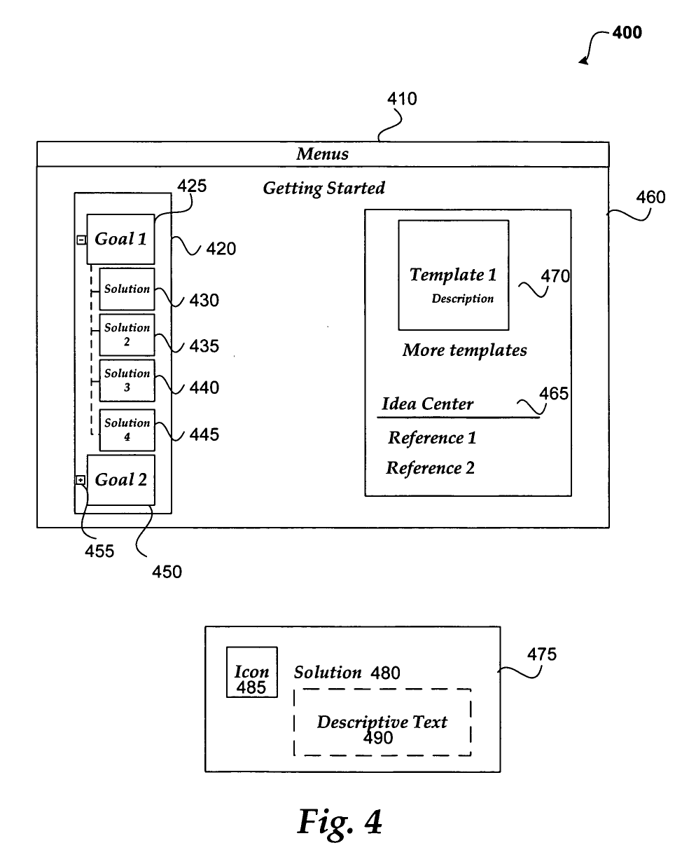

FIG. 4 illustrates an exemplary getting started user interface, in accordance with aspects of the invention. As illustrated, screen 400 includes goal list 420, menus 410, application window 460, idea center 465 and template section 470. Solutions 430, 435, 440 and 445 are solutions that have been determined to assist a user in reaching goal 1 (425). Each of the goals within the goal list has one or more associated solutions.

Instead of having to search through the menus (410) of the application for a specific menu item to perform, or having to initially select a correct template as a starting point, the user may select one of the goals (425, 450) from list 420 that provides the user with a list of solutions and resources that are used to get the user started.

The goals are created such that they assist the user in starting a project using an application. Selecting one of the goals may lead the user to resources such as templates, application features, Help topics, network site locations such as Web sites, and/or to further ideas. The goals included within interface 420 may be customized based upon the end user. For example, different goals may be provided for different target audiences without having to change the underlying application. The goals and results may also be customized based on other criteria. For instance, a user could download goals/results from a vendor. The list may also be changed based on the user's prior selections and/or actions within the program.

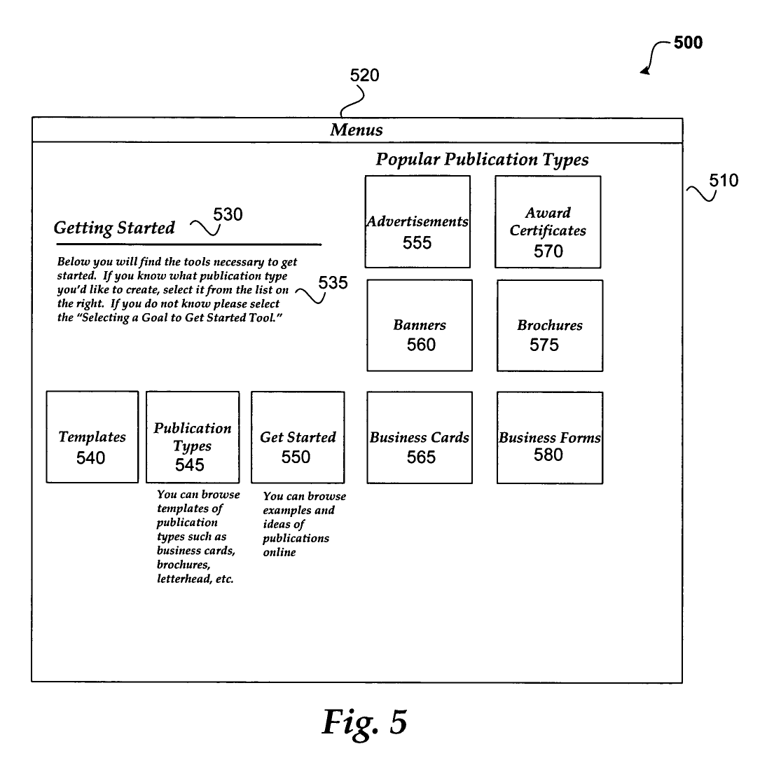

The goals may be included within an interface in many different ways. In one embodiment, the goals are exposed in a hierarchical view which uses a tree-control (455) to hide and collapse the solutions (430, 435, 440 and 445) depending on the state of the control. In addition to the link text which is used to identify the goal and/or solution, they may include and/or reference other related information. For example, the solution may include a link description 480, an icon 485, and descriptive text 490. The goals may also be displayed in a simple list (See FIGS. 5-7 and related description).

Referring to goal list 420, a user may quickly view and select a goal to get started. Utilizing goal list 420, the user does not need to be familiar with all of the features of an application before starting a project. For example, if the goal was to attract new customers, a solution may be provided to the user to create a marketing document that uses one of the available templates. The user also does not need to know how to achieve a desired goal. A list of solutions is provided to the user from which they can select to get started rather than requiring them to extensively search through menu items and/or other current user interface constructs.

FIGS. 5-7 show exemplary screen displays illustrating a getting started example, in accordance with aspects of the present invention. While the example illustrates getting started within a publication program and selecting a goal relating to marketing, any number and/or type goals may be designed and created and be associated with one more applications and/or resources.

FIG. 5 illustrates an exemplary getting started user interface, in accordance with aspects of the invention. As illustrated, screen 500 includes display 510 that provides the user with information relating to the application as well as allowing the user the option of selecting a goal to get started.

Getting started section 530 includes a description (635) that informs the user how to get started. They may either select one of the resources they already know about or they may select “Get Started” button 550, which provides the user with a list of goals. In the present example, menus 520 are menu items relating to a publishing application. Similarly, buttons 540, 545, 550, 555, 560, 565, 570, 575 and 580 are resources relating to the publication application. Templates 540 are templates that may be selected by a user to get started. Publication types 545 are different types of publication templates that may be used to get started. Popular publication types show the user the types of publications that are commonly created (555, 560, 565, 570, 575 and 580) using the publication application.

When the user does not know how to get started using the application and/or wants more ideas on getting started, the user may select the “Get Started” button (550). Once selected, the user will be presented with a list of goals to assist the user in getting started using the application.

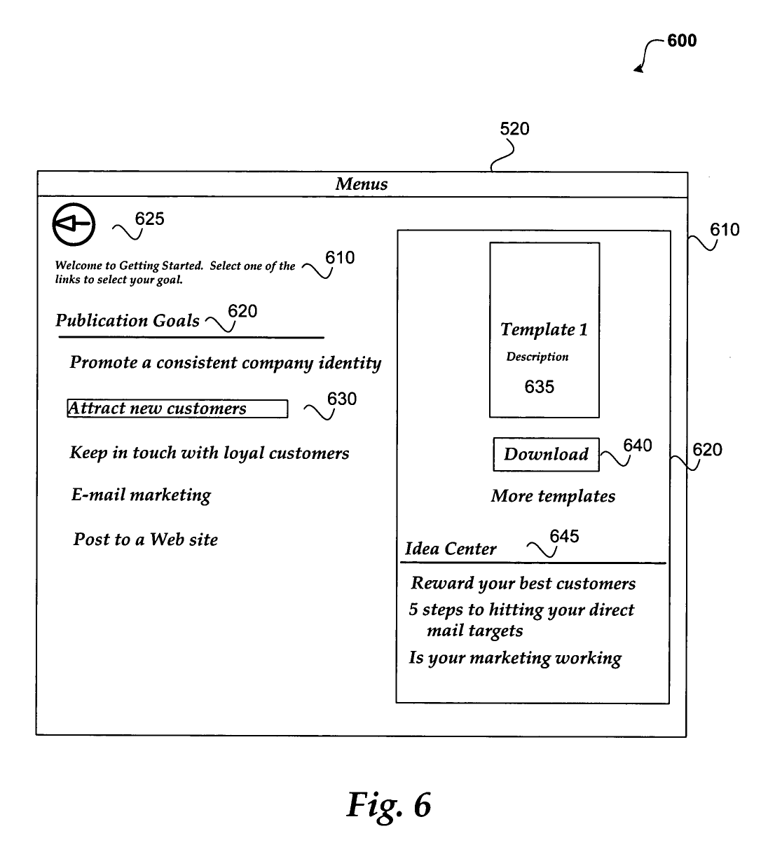

FIG. 6 shows an exemplary getting started screen (600), in accordance with aspects of the invention. After selecting the “Get Started” button (550), display 610 is updated with a list of goals (620) that may be selected by a user to get started using the application. Description 610 welcomes the user to the getting started interface and informs the user to select one of the displayed links to get started.

The goals section (620) of the display (610) contains goal and/or task-based statements that when selected display the various solutions and resources that relate to the selected goal. For instance, selecting the “attract new customers” goal (630) displays the publications that may be used in this goal. Since the list of goals may be stored separately from the executable it may be updated at any time. In this example, the publication goals section (620) includes five goals: promote a consistent company identity; attract new customers (630); keep in touch with loyal customers; e-mail marketing; and post to a Web site. In some examples there will be more goals and in other examples there will be fewer goals. According to one embodiment, the specific list of goals and resulting publications is determined by a consultant who is familiar with the users utilizing the application.

The user may also browse through templates (635) and download templates (640). According to one embodiment, the set of templates (635) are displayed as a way to spark ideas, showcase new content, and to help inform users of additional content that is available to them. The content may be static or be changed periodically. For instance, the content may be changed each time the user opens a new instance of the application.

An idea center (645) is also provided that includes further ideas that relate to the target audience and the listed goals. The user may use arrow button 625 to return to the previous top level screen.

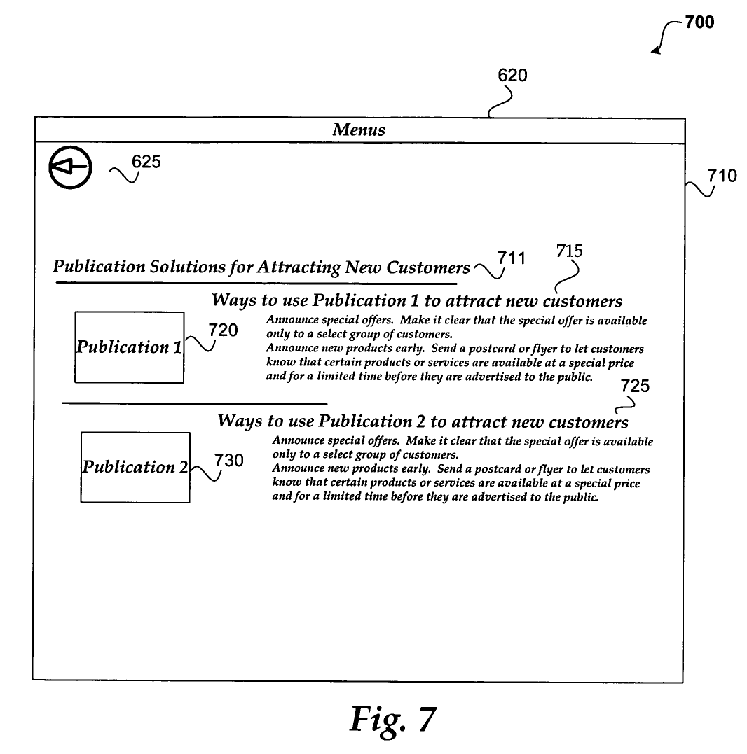

FIG. 7 illustrates a list of resources relating to the selected goal, in accordance with aspects of the present invention.

Results screen 700 shows the user publication solutions for attracting new customers (711). In this particular example, the list in display 710 shows two different publication solutions: Publication 1 (720) and Publication 2 (730) that relate to attracting new customers.

Each solution consists of a label (715, 725), a thumbnail (720, 730) and a description. Users can click on the thumbnail and the label to be directed to the particular publication and get started with their project.

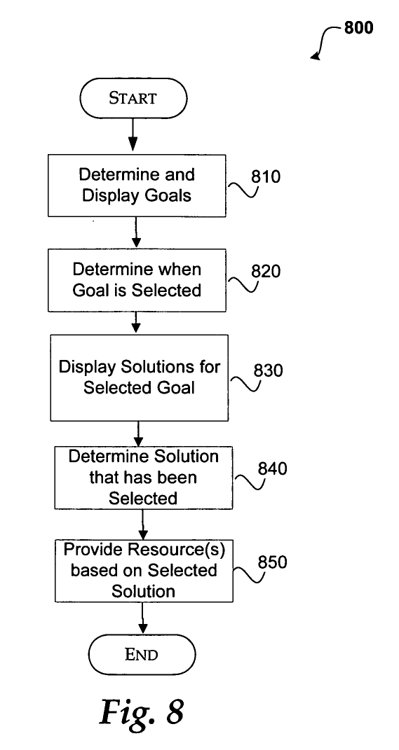

FIG. 8 shows a getting started process, in accordance with aspects of the present invention.

After a start block, the process flows to block 810 where a list of goals is displayed. As discussed above, the goal is generally related to the application and is used to help the user get started using the application. For example, when the application is a publishing application, the goals are typically related to producing a publication that is associated with the publishing application. Many goals may be defined for each application. These goals may also be customized and targeted for a user or a set of users.

Moving to block 820, a determination is made as to when a goal is selected. Once selected the process moves to block 830. At block 830, at least one solution for the goal is displayed. The solution may be resources from within the application and/or resources from outside of the application.

Moving to block 840, a solution is selected. Flowing to block 850, the resources are provided based on the selected solution. According to one embodiment, selecting the solution leads the user to templates, application features, Help topics, network site locations such as Web sites, and/or to further resources.

Illustrative Operating Environment

With reference to FIG. 1, one exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 may include a getting started program 120. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 may also contain communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for providing assistance to get started using an application, comprising:
displaying a list of goals within a user interface of the application before a project has been started within the application; and
determining when one of the goals is selected; and when one of the goals is selected, providing a solution which may be used to get started on the project;
wherein the solution may include resources from within the application and outside of the application.

2. The method of claim 1, further comprising determining when the solution is selected and in response to the selection providing a resource that may be used to get started on the project.

3. The method of claim 2, wherein the resource is a template.

4. The method of claim 2, wherein the resource is a publication type relating to the application.

5. The method of claim 2, wherein providing the resource comprises providing at least one of: application functionality, a network reference, an article, and a publication.

6. The method of claim 1, wherein the listed goals are related to a publishing application.

7. The method of claim 1, further comprising displaying a template section that includes templates that are related to the listed goals.

8. The method of claim 1, further comprising displaying an idea center within the user interface that includes references related to the listed goals.

9. The method of claim 8, further comprising changing the displayed references periodically.

10. The method of claim 1, further comprising storing the list of goals externally from the application such that the list of goals may be updated when the list of goals is changed.

11. A computer-readable medium having computer-executable instructions for getting started using an application, comprising:
determining goals that are related to a target audience that uses the application;
displaying at least a portion of the goals within a user interface of the application before a project within the application is started; and
determining when a goal is selected; and in response to the selection, providing a solution to the goal that utilizes resources that are associated with the application.

12. The computer-readable medium of claim 11, wherein providing the solution comprising determining when the solution is selected and in response to the selection providing a resource that may be used to get started on the project, wherein the resource may be a resource that is external to the application.

13. The computer-readable medium of claim 12, wherein providing the resource comprises providing a template.

14. The computer-readable medium of claim 12, wherein providing the resource comprises providing a type of publication that may be created by the application.

15. The computer-readable medium of claim 12, wherein providing the resource comprises providing at least one of: application functionality, a network reference, and an article.

16. The computer-readable medium of claim 11, wherein the determined goals are related to a publishing application.

17. The computer-readable medium of claim 11, further comprising displaying a template section within the user interface that includes a selection of templates that are related to the determined goals.

18. The computer-readable medium of claim 11, further comprising displaying an idea center within the user interface that includes references related to the listed goals and that are periodically updated within the user interface.

19. An apparatus for providing assistance to get started on a project using an application, comprising:
means for displaying a list of goals within a user interface of the application before a project has been started within the application; and
means for determining when one of the goals is selected; and when one of the goals is selected:
means for providing solutions for the goal which may be used to get started on the project; wherein the solution may include resources from within the application and outside of the application; and
means for determining when a solution is selected, and in response to the selection providing a resource that may be used to get started on the project.

20. The apparatus of claim 19, further comprising means for displaying an idea center within the user interface.
